(19) United States
(12) Patent Application Publication
(10) Pub. No.: US 2026/0289796 A1
(43) Pub. Date: Sep. 24, 2026

(54) METHOD FOR DETERMINING A PRODUCTION FREQUENCY OF A SERIES OF DROPS MOVING IN A FLUIDIC CHANNEL

(71) Applicant: HEKAT, PESSAC (FR)

(72) Inventor: Mathias GIRAULT, TALENCE (FR)

(21) Appl. No.: 19/474,649

(22) PCT Filed: Mar. 28, 2024
(86) PCT No.: PCT/EP2024/058649

§ 371 Date: Oct. 10, 2025

(30) Foreign Application Priority Data
Apr. 12, 2023 (FR) FR2303628

(51) Int. Cl. G06T 7/246; G01N 15/1433; G06T 7/64

(52) U.S. Cl. CPC G06T 7/246; G01N 15/1433; G06T 7/64

(57) ABSTRACT

The invention relates to a method for determining a frequency of production of a series of drops (2) moving in a fluidic channel (31), the method comprising the following steps:
using a rolling-shutter image capture device (11) to acquire an initial image of at least two drops in series in the fluidic channel, the initial image comprising a matrix array of pixels forming rows and columns, the rows being acquired sequentially in succession by way of the rolling shutter;
detecting, based on the initial image, a contour of at least one of the two drops;
computing the frequency of production on the basis of the contour, of a period between the acquisition of two successive rows of pixels, and of a distance between the two drops.

### TECHNICAL FIELD

The present invention generally relates to the technical field of fluidics.

More particularly, it relates to a method for determining a frequency of production or of passage of a series of drops moving in a fluidic channel.

The invention finds a particularly advantageous application in slaving the drop production frequency to a reference frequency.

### TECHNOLOGICAL BACKGROUND

Obtaining a regular production of a series of drops in a fluidic system, in particular in microfluidic systems, i.e. at a predetermined reference or set-point frequency, is a major challenge, particularly with a view to dynamic sorting of these drops. However, it is not enough that the pressure or injection flow rate of the fluids, typically oil and water, are fixed to obtain regular production of drops in series, in particular microdroplets.

Indeed, the drop production frequency depends on the pressure within the fluidic channel in which the drops are produced, and this pressure within the canal takes some time to build up. The narrower the channel, the longer it takes. Therefore, with constant fluid injection pressure and flow rate, the drop production frequency varies over time.

It is therefore necessary to measure this production frequency on the drops moving within the channel to compare it with the reference frequency in order to be able to establish a counter-reaction by adjusting the fluid injection pressure or flow rate.

Electrical methods exist, based on an impedance or wave drop detection, to measure the drop production frequency. However, these methods suffer from a low maximum detectable frequency (below 3 kHz) because the drops have to be spaced apart enough to be detected. These methods are thus unsuitable for a large number of applications.

There also exist optical methods making it possible to measure higher production frequencies, liable to reach several tens of kilohertz. Some of these optical methods are based on a fluorescent encoding, which requires to fill the drops with a fluorescent liquid, to use a laser and a very sensitive detector (because the fluorescent signal is low). To do without fluorescence, other methods are based on very high frequency imaging combined with serial drop counting. In both cases, these methods require expensive detectors.

This led to the need for low-cost measurement of the drop production frequency in the fluidic channel.

### SUMMARY OF THE INVENTION

In this context, the present invention proposes a method for determining a production frequency of a series of drops moving in a fluidic channel, the method comprising the following steps:
acquiring, using a rolling-shutter image capture device, an initial image of at least two drops in series in the fluidic channel, the initial image comprising a matrix of pixels forming rows and columns, the rows being acquired sequentially one after the other by way of the rolling shutter;
detecting, from the initial image, a contour of at least one of the two drops;
calculating the production frequency based on the contour, on a delay between the acquisition of two successive rows of pixels and on a distance between the two drops.

Therefore, thanks to the invention, the drop production frequency is determined using a rolling-shutter image capture device, i.e. an inexpensive image capture device. The rolling-shutter image capture devices are indeed very cheap, in particular compared to global shutter devices used in the very high frequency imaging methods of the prior art.

Remarkably and counter-intuitively, the contour of a drop provides information about the movement of the drop in the channel thanks to the time information contained in the image. Indeed, as this single image is acquired row by row, i.e. sequentially, the shape of the drop contour in this image depends on the drop velocity. Therefore, evaluating a deformation of the drops via their contour thus enables to determine their movement in the channel.

As a result, by combining the deformation measurement (which makes it possible to deduce the deformation rate) with a simple measurement of the distance between the two drops, the invention makes it possible to determine the production frequency in a cheap way. Advantageously, the method of the present disclosure requires no fluorescent encoding of the drop.

Remarkably, the initial image being composed of pixels, the deformation rate is expressed in pixels per unit of time and the distance between the two microdroplets is expressed in pixels. Therefore, the dimension of the deformation rate to distance ratio, i.e. the production frequency, is directly the inverse of a time. Thus, it is not necessary to determine the drop velocity in metres per unit of time, which requires to determine a great number of parameters of the optical system, in particular the magnification of the optical imaging system.

In other words, the method according to the invention requires no calibration to determine the drop production frequency because the “pixel” dimension is eliminated in the deformation rate to distance ratio. In particular, this makes the invention very easy to implement.

Other non-limiting and advantageous features of the method according to the invention, taken individually or according to all the technically possible combinations, are the following:
it is provided to: construct derived images from the initial image, each derived image being associated with an offset value, the rows of each derived image being successively translated, with respect to their position in the initial image, by a number of pixels proportional to the offset value associated with said derived image; detect, on each derived image, a derived contour of said at least one of the two drops; determine the production frequency based additionally on the derived contours deduced from the derived images;
the offset values increase from 1 to a positive integer and each row of each derived image is translated, with respect to its position in the initial image, by a number of pixels equal to the offset value multiplied by an index of said row;
it is provided to: calculate a circularity index of each derived contour associated with each derived image; determine a fitting curve of the circularity indices as a function of the offset values; determine the production frequency as a function of a minimum of the fitting curve;
it is provided to determine a deformation, which is representative of a difference between a shape of said at least one of the two drops in the initial image and a circular shape, based on a position difference between a first end of said at least one of the two drops in a row of pixels which is acquired first during acquisition step and a second end of said at least one of the two drops in another row of pixels which is acquired last during acquisition step, the production frequency being also calculated based on the deformation;
it is provided to: detect a contour of the other of the two drops, calculate the production frequency based on an average of the contour of said at least one of the two drops and on the contour of the other of the two drops;
an acquisition time of the initial image is less than 10 ms;
the fluidic channel having a longitudinal direction, it is provided, before the acquisition step, to arrange the image capture device with respect to the fluidic channel in such a way that, in the initial image, the longitudinal direction of the fluidic channel forms an angle of less than 10 degrees with the rows;
it is provided to light the fluidic channel and said at least two drops all along the acquisition using a light source;
it is provided to determine a centre of gravity of each of the two drops and to calculate the distance between the two drops as the distance between the two centres of gravity;
it is provided to determine a velocity of said at least one of the two drops based on the contour, on the delay and taking into account at least one optical parameter of the image capture device or a predetermined distance represented in the initial image.

The invention also proposes a method for producing a series of drops, the series of drops moving in a fluidic channel of a fluidic device, the method comprising the following steps:
selecting a reference frequency for producing the series of drops;
determining a production frequency of the series of drops in the fluidic channel by a method as described hereinabove;
comparing the production frequency and the reference frequency;
determining, based on the comparison, a flow rate or pressure set-point for a fluid injected into the fluidic device upstream from the fluidic channel to produce the series of drops.

The invention also relates to a device for determining a production frequency of a series of drops moving in a fluidic channel, the system comprising a rolling-shutter image capture device adapted to acquire an initial image of at least two drops in series in the fluidic channel, the initial image comprising a matrix of pixels forming rows and columns, the rows being acquired sequentially one after the other using the rolling shutter, and a calculator programmed for:
detecting, from the initial image, a contour of at least one of the two drops;
calculating the production frequency, based on the contour, on a delay between the acquisition of two successive rows of pixels and on a distance between the two drops.

The invention finally relates to a drop sorting system comprising a device as described hereinabove.

Advantageously, the system is a microfluidic device or a flow cytometer.

Obviously, the different features, alternatives and embodiments of the invention can be associated with each other according to various combinations, insofar as they are not incompatible or exclusive with respect to each other.

### Description of the Invention

The following description in relation with the appended drawings, given by way of non-limiting examples, will allow a good understanding of what the invention consists of and of how it can be implemented.

### IN THE APPENDED DRAWINGS

FIG. 1 is a schematic view of a system for determining a production frequency of drops moving in a fluidic channel.

FIG. 2 is a schematic illustration of an image acquisition by a rolling shutter showing operations on rows of sensors as a function of time (t).

FIG. 3 is a block diagram of a sequence of steps enabling to determine the velocity and the production frequency of drops moving in a fluidic channel using the system of FIG. 1.

FIG. 4 is an image, sequentially acquired using the system of FIG. 1, of a plurality of drops moving in a fluidic channel.

FIG. 5 is an image derived from the image of FIG. 4 constructed by offsetting the rows of pixels with a first offset value.

FIG. 6 is another image derived from the image of FIG. 4 constructed by offsetting the rows of pixels with another offset value.

FIG. 7 is still another image derived from the image of FIG. 4 constructed by offsetting the rows of pixels with still another offset value.

FIG. 8 shows a processing of the image of FIG. 6 illustrating drop contour determination.

FIG. 9 is a graphic representation of circularity indices of the drops on derived images (as shown in FIGS. 6, 7 and 8) as a function of the offsets used to construct the derived images, as well as a fitting curve enabling to determine an optimum offset value.

FIG. 10 is a schematic representation of one drop of the plurality of drops of FIG. 4 enabling to determine a deformation of the drops.

FIG. 11 is a block diagram of a sequence of steps enabling the production of drops with a regulation of their production frequency.

FIG. 12 is a schematic representation of a drop (left) and a sequentially acquired image of this drop (right), the drop moving perpendicularly to the rows of pixels during image acquisition.

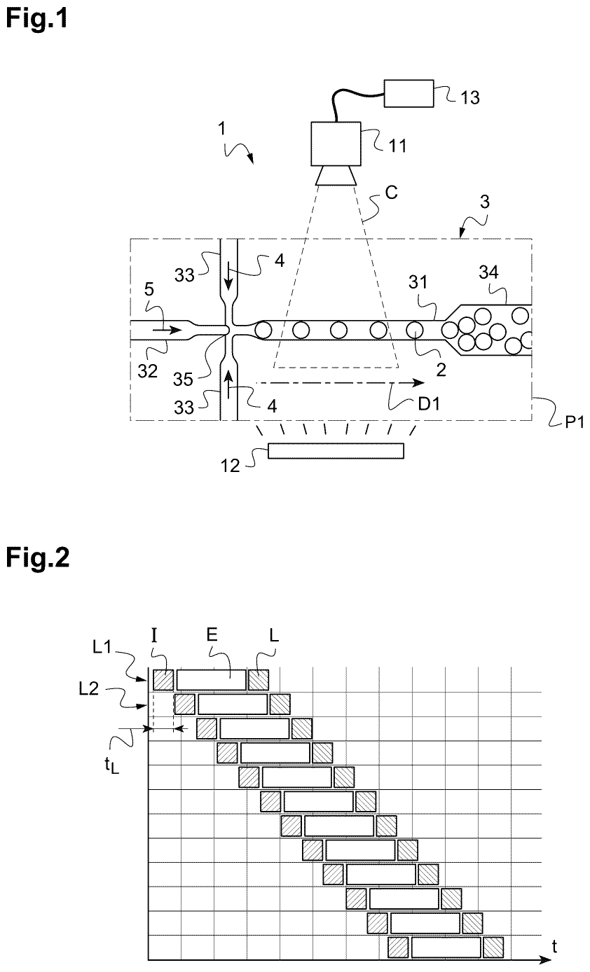

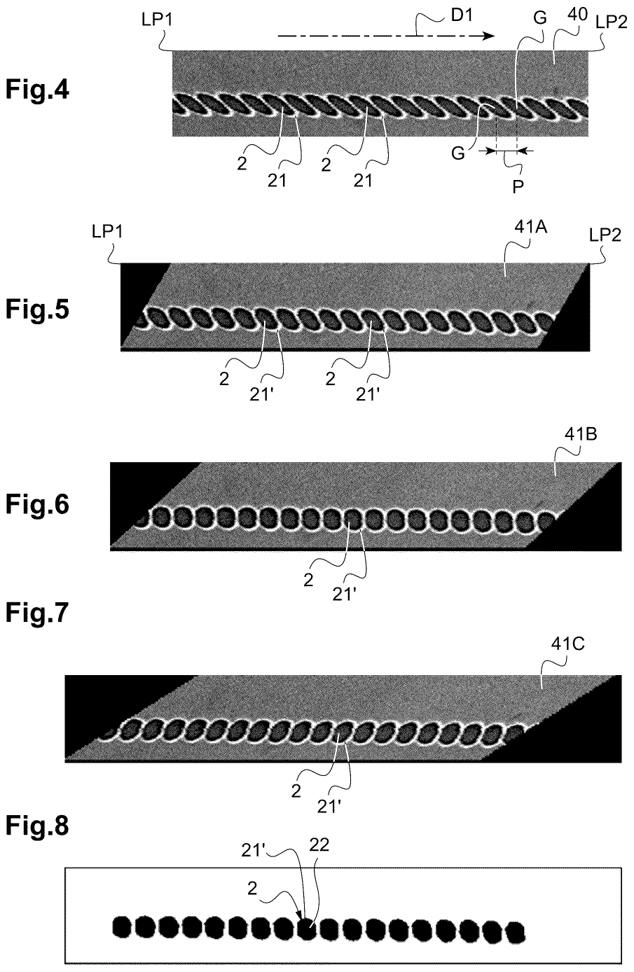

FIG. 1 shows a system 1 for determining a production frequency fp of a series of drops 2 moving in a fluidic device 3. More particularly, the drops 2 move in a fluidic channel 31 of the fluidic device 3. As shown in FIG. 1, the fluidic channel 31, hereinafter called the channel 31, is here rectilinear in a longitudinal direction. The drops 2 thus have a rectilinear translation movement in the channel 31. In FIG. 4, the drops 2 move rectilinearly from the left to the right, parallel to the longitudinal direction of the channel 31. As show in FIG. 1, the drops 2 of the series are located one behind the other along the longitudinal direction, which means that the series of drops 2 forms a row of drops 2.

In the exemplary embodiment described here, i.e. with reference to FIGS. 1 to 11, the fluidic device 3 is more particularly a microfluidic device 3, also called microfluidic chip, as shown in FIG. 1. In this example, the channel 31 is then a microfluidic channel. The cross-section of the channel 31 is then for example between 10 μm² and 150,000 μm² and the length between 50 μm and 1 cm. The drops 2 are then more particularly microdroplets 2, which means that their size, i.e. here their diameter, is for example between 1 μm and 300 μm.

The drops 2 have, in the channel 31, a shape that is generally spherical or a flattened sphere shape. The fluidic device 3 is here substantially planar. The plane of the fluidic device 3, referenced P1 in FIG. 1, is in particular parallel to the main direction. In parallel with this plane P1, the drops 2 have a circular shape, which means that their contour is generally a circle.

The microfluidic device 3 also comprises a central injection channel 32 and two lateral injection channels 33 leading to a junction 35 with the central channel 32, on either side of this junction 35, and perpendicular to it. The central channel 32 contains a sample liquid that is for example pure water or an aqueous medium such as a phosphate buffer saline (PBS), and the lateral channels 33, a cladding liquid, for example oil. In this case, the drops 2 are then microdroplets of water in suspension in oil. The drops 2 are produced when the oil flows 4 split the water flow 5 into distinct volumes. The production of the drops 2 here occurs at the junction 35 of the central channel 32 with the lateral channels 33. After having travelled through the channel 31, the drops 2 are for example collected in a tank 34 connected at the exit of the channel 31.

Preferably, the drops 2 are sorted (mechanism not shown) before being collected. For that purpose, the drops 2 are for example analysed by fluorescence using a laser. When a drop of interest is detected, it is then extracted from the channel and directed into a collection channel. Knowing the production frequency fp of the drops 2 is then important to synchronize the extraction of the drop from the liquid flow.

Other configurations of the microfluidic device 3 are conceivable. Likewise, other sample liquids and other cladding liquids may be used, for example to form microdroplets of oil in suspension in water.

As an alternative of the example shown in the figures, the fluidic device is a flow cytometer. The drops then have a diameter that is for example between 30 μm and 300 μm. The fluidic channel can then be open in the sense that it is not delimited by glass or plastic walls but by air. The drops are produced in the flow by vibration of a piezoelectric actuator.

Generally, the production frequency fp of the drops 2 is here defined as the inverse of the time separating the production of two successive drops 2, i.e. two drops 2 produced one after the other. The production frequency fp is here equal to the frequency of passage in the microfluidic channel 31.

As shown in FIG. 1, the system 1 comprises an image capture device 11 arranged so as to acquire at least one image of the drops 2. The channel 31 comprising the drops 2 is located in the field of view C of the image capture device 11. Here, the system 1 also comprises a light source 12 located at the opposite of the image capture device 11 with respect to the channel 31. The channel 31 is thus interposed between the light source 12 and the image capture device 11 so as to be imaged by transparency. As an alternative, the lighting may be on the same side as the image capture device, by reflection on the fluidic device 3.

To simplify understanding, FIG. 1 schematically shows two planes that are in practice distinct from each other and more particularly orthogonal to each other. A first plane is the plane P1 of the fluidic device 3 (corresponding to the plane of the figure) and a second plane is that along which are aligned the image capture device 11 and the light source 12. In other words, the image capture device 11 and the light source 12 are in practice aligned along a direction perpendicular to the plane of FIG. 1 and the fluidic device 3 shown in FIG. 1 corresponds to an image that could be acquired by the image capture device 11.

The image capture device 11 more particularly comprises a rolling shutter. Each image acquired by the latter is then sequentially acquired in the sense that it is acquired row by row.

Conventionally, the rolling shutter is here implemented electronically.

The image capture device 11 more particularly comprises a detector consisted of a plurality of sensors, here CMOS sensors, arranged as a matrix forming rows L1, L2 and columns (the terms rows and columns are interchangeable because they are conventional). The operation of the image capture device 11 is illustrated in FIG. 2. Each image is acquired sequentially, row of sensors by row of sensors. The first row L1 of sensors, here the upper one, is initialized (bloc I in FIG. 2), then it integrates the light coming from the channel 31 lighted by the light source 12 (bloc E in FIG. 2), then the electric signals produced by the sensors are read (bloc L in FIG. 2), i.e. collected by a dedicated electric circuit. The second row L2 of sensors is acquired with a time offset with respect to the first row L1. This means that: i) the second row L2 is initialized after the end of initialisation of the first row L1, ii) the integration times of the two rows are partially superimposed, iii) the second row L2 is read after then end of reading of the first row L1. As shown in FIG. 2, it is the same for the following rows.

Therefore, the rolling shutter mechanism is obtained by an electronic unwinding of the detector.

Each acquired image comprises a matrix of pixels forming rows and columns. In FIG. 4, the rows of pixels extend from right to left and the columns from top to bottom. The rows of pixels correspond to the rows L1, L2 of sensors and the columns of pixels correspond to the columns of sensors. In other words, each image is also acquired sequentially row of pixels by row of pixels. Therefore, an object moving in the field of view C of the image capture device 11 during acquisition of the image appears deformed because its different portions are acquired by different rows L1, L2 of sensors at successive moments.

The image capture device 11 also comprises its own processor designed to interpret the signals collected by the dedicated electrical circuit in order to construct the images.

The time between acquisition of two successive rows of sensors, hereinafter called row time t_{L}, is an intrinsic feature of the image capture device 11. The row time t_{L} is more specifically equal to a delay between two identical actions of the image capture device 11 on two successive rows of sensors, for example the first row L1 and the second row L2. The row time t_{L} thus corresponds to the above-mentioned time offset. The row time t_{L} is thus also equal to the delay between acquisition of a row of pixels and acquisition of the following row of pixels, i.e. the delay between acquisition of two successive rows of pixels, the acquisition of a row of pixels starting at the initialisation (block I) of the corresponding row of sensors.

The row time t_{L} is for example the delay between the beginning of initialisation of a row of sensors and the beginning of initialisation of the following row of sensors (as shown in FIG. 2) or also the delay between the beginning of reading of one row and the beginning of reading of the following row of sensors. In practice, this information is supplied by the manufacturer of the image capture device 11. Preferably, the image capture device 11 is selected in such a way as to have a row time t_{L} of less than 10 μs. The row time t_{L} corresponds to a building parameter of the rolling-shutter image capture device 11. The row time t_{L} remains constant for a given rolling-shutter image capture device.

As shown in FIG. 1, the system 1 also comprises a calculator 13 configured to control the image capture device 11. The calculator 13 here comprises at least one memory and at least one processor. The memory is a computer-readable recording medium comprising instructions that, when executed by the processor, make it possible to control the image capture device 11. The calculator 13 is in particular configured to trigger the image captures.

The calculator 13 is more particularly programmed to implement a method for determining the production frequency fp of the drops 2, and that based on the capture of a single image 40, hereinafter called the initial image 40, by the image capture device 11. This method is implemented here by the system 1. Of course, it can be implemented by any suitable system that is based on a sequential acquisition of images.

The method for determining the production frequency fp comprises the following main steps:
acquiring, using the rolling-shutter image capture device 11, the initial image 40 of at least two drops 2 in the channel 31;
detecting, from the initial image 40, a contour 21 of one of the two drops 2;
determining, based on the contour 21, a deformation rate T of the drop 2;
determining a distance between the two drops 2;
calculating the production frequency fp based on the deformation rate T, on the row time t_{L}, and on the distance between the two drops 2.

The method here comprises a step of determining the deformation rate T, which is an intermediate parameter used for determining the production frequency fp. The deformation rate T is representative of the movement, i.e. the velocity, of the drop 2 in the channel 31. The deformation rate T here corresponds to a partially dimensionless value of the velocity of the drops 2 in the sense that it is expressed in pixels per unit of time. The deformation rate T depends on the velocity of the drops 2 and the arrangement of the image capture device 3 relative to the channel 31.

The contour 21 of the drop 2 provides information about the movement of the drop 2 during acquisition of the initial image 40. Indeed, as the drop 2 moves forward during acquisition, its contour 21 appears distorted in relation to a circle.

Preferably, the method comprises a previous step (not shown) of arranging the image capture device 11 relative to the channel 31 in such a way that, in the initial image 40, a main direction D1 along which the drops 2 moves or the longitudinal direction of the microfluidic channel 31 forms a angle of less than 10 degrees with the rows of pixels. Here, the longitudinal direction of the microfluidic channel 31 is parallel to the main direction D1.

Still more preferentially, the initial image 40, the main direction D1 or the longitudinal direction of the microfluidic channel 31 is parallel to the rows of pixels, as in FIG. 4, in which two rows of pixels LP1, LP2 are shown.

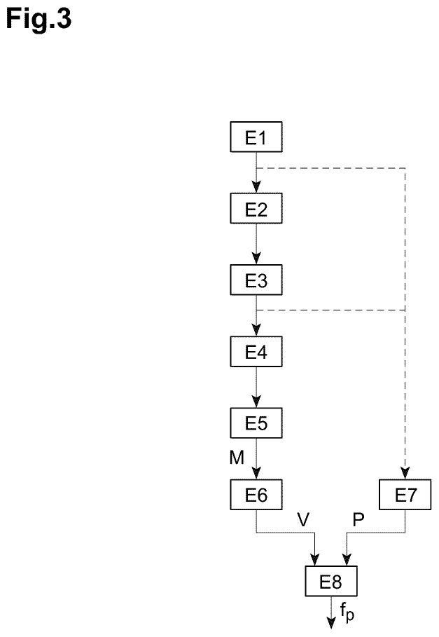

As shown in FIG. 3, the method more particularly begins by a first step E1 of acquiring the initial image 40. During the first step E1, the light source 12 is here lighted. Preferably, the light source 12 is continuously lighted during the whole method duration.

In the example shown in FIG. 4, a plurality of drops 2, here about twenty drops 2, is included in the field of view C during acquisition of the initial image 40. As a consequence, the plurality of drops 2 is shown in the initial image 40. As will become apparent later, having several drops 2 in the initial image 40 enables average (or median) values to be determined, which increases the accuracy of determination of the production frequency fp. The drops 2 of this plurality, i.e. the drops 2 represented in the initial image 40, are thereafter called “the drops”.

However, the production frequency fp can be determined based on only two drops 2. In other words, imaging only two drops 2 (thus successive ones) can be sufficient to determine the distance and thus the production frequency fp. On the other hand, imaging only one drop 2 is sufficient to determine the deformation rate T.

The portion of the channel 31 that is imaged is here regular, in the sense that it has a constant cross-section over the whole initial image 40. Therefore, the drops 2 all moves with the same velocity, and their deformation rate T is thus identical. As an alternative, when the portion of the channel 31 that is imaged is irregular, only a regular section, or the more regular possible section, of this portion is taken into account in the method.

As explained hereinabove, the initial image 40 is acquired row of pixels by row of pixels. Here, the first row LP1 located on top of FIG. 4 is acquired first, the other rows are acquired successively starting from the first row LP1.

Advantageously, when the main direction D1 is parallel to the rows of pixels, corresponding portions of the drops 2 are acquired simultaneously because located on a same row of pixels. The deformations of the different drops 2 shown in the initial image 40 are thus substantially identical, which increases the accuracy of determination of the deformation rate T.

In a first embodiment of the method for determining the deformation rate T, shown in FIG. 3, the determination of the deformation rate T is based on the construction of derived images 41. The idea of this first embodiment is to re-align the initial image 40 using the derived images 41 so as to obtain drops 2 of circular shape over at least one derived image 41. The re-alignment enabling to obtain a circular shape provides information about the movement of the drops 2 during acquisition of the initial image 40, and hence the deformation rate T of the drops 2.

Therefore, in the first embodiment, the method continues with a second step E2 in which the calculator 13 constructs the derived images 41.

The second step E2 first comprises determining offset values. Generally, the offset values are positive integers distinct from each other. The offset values are preferably all the positive integers from 1 to a maximum offset value N. The offset values can also vary from n to N in steps of p, with n≥1 and p≥1, for example n=p=5. This makes it possible to reduce calculating time, at the expense of accuracy in determining the deformation rate T. The maximum offset value N is here predetermined. It is for example between 20 and 1000. The maximum offset value N can here depend on an estimated velocity of the drops.

Each derived image 41 is bijectively associated with an offset value. Each derived image 41 is then constructed by successively translating the rows of pixels by a number of pixels proportional to the offset value that is associated with said derived image 41. Translating here means moving or shifting the rows of pixels with respect to their position in the initial image 40. In other words, the translation is an offset in the direction of the rows of pixels (i.e. from the right to the left in FIG. 4). The rows of pixels are translated opposite to the movement of the drops 2, i.e. in the opposite direction to the movement of the drops 2. This makes it possible to compensate, on the derived images 41, for the deformation of the drops due to their movement during acquisition of the image 41. Here, with reference to FIG. 4, the rows of pixels are hence translated towards the left because the drops move towards the right.

Each row of pixels of each derived image 41 is more specifically translated by a number of pixels equal to the offset value multiplied by an index of said row of pixels. By convention, in the initial image 40 illustrated in FIG. 4, the indices are here positive integers counted from the top row, of index 1, to the bottom row. The construction of derived images 41 is illustrated in more details in FIGS. 5, 6 and 7.

FIG. 5 illustrates a first derived image 41A corresponding to the offset value 5, starting from the initial image 40 shown in FIG. 4. The first row LP1, i.e. the top row of index 1, is translated by 5 pixels (5×1) to the left. Thereafter, the second row LP2, i.e. the row in second position from the top and of index 2, is translated by 10 pixels (5×2) to the left. The first row LP1 and the second row LP2, which strictly face each other in the initial image 40, are thus now offset by 5 pixels with respect to each other in the first derived image 41A. Iteratively, the third row of index 3 is translated by 15 pixels and so on.

FIG. 6 illustrates a second derived image 41B corresponding to the offset value 10, starting from the initial image 40 shown in FIG. 4. The first row of index 1 is translated by 10pixels (10×1), the second row of index 2 by 20 pixels (10×2), and so on. FIG. 7 illustrates a third derived image 41C corresponding to the offset value 15, starting from the initial image 40 shown in FIG. 4. The first row of index 1 is translated by 15 pixels (15×1), the second row of index 2 by 30 pixels (15×2), and so on. In FIGS. 5 to 7, the shape of the drops 2 seams to be the closest to a circular shape for the offset value 10. Beyond the value 10, the circularity of the drops 2 deteriorates again.

By way of example, 25 derived images 41 are constructed at the second step E2 for offset values going from 1 to 25 in steps of 1.

Once the derived images 41 constructed, the method continues with a third step E3 of detecting the contours 21′ of the drops 2 on the derived images 41. The contours of the drops 2 on the derived images 41 are hereinafter called derived contours 21′.

During the third step E3, the calculator 13 detects more particularly the derived contour 21′ of each drop 2 on each derived image 41. Here, only the drops 2 entirely shown are taken into account, those which are partially shown and located at the edge of the image are excluded.

The derived contours 21′ are for example detected by thresholding the pixel intensity. Indeed, as shown in FIGS. 4 to 7, there exists a contrast between the sample liquid and the cladding liquid, which makes it possible to extract the surface areas 22 corresponding to the drops 2. The drops 2 are here darker than the cladding liquid. However, the drops 2 can also appear lighter than the cladding liquid or sometimes as a simple white or black border corresponding to the contour (only the contours are then visible). The method for extracting the derived contours 21′ is adapted to the situation.

The surface areas 22 of the drops shown in FIG. 6 are for example illustrated in FIG. 8. As shown in FIG. 8, the derived contours 21′ are then determined as the edge of these surface areas 22. Preferably, the intensity thresholding is local.

The derived contours 21′ can also be detected using a contour detection filtering, such as a Sobel filter or a Kany filter, or thanks to a filter for searching circular objects, for example by a Hough transform.

The method then comprises a fourth step E4 wherein the calculator 13 calculates a circularity index of each derived contour 21′. A circularity index is a value, in this case a positive real value, representative of the proximity in shape of a contour 21 or a derived contour 21′ to a circle. A circularity index of a contour 21 or a derived contour 21′ of a drop 2 is for example calculated based on a ratio between the perimeter of the drop 2 and the surface area of the drop 2. Here, the circularity index is calculated according to the Heywood index. It can also be calculated based on a ratio between a long axis and a short axis of the drop 2.

Here, for each derived image 41, an average circularity index is calculated as the average of the circularity indices of each drop 2 shown in the derived image 41. Following the previous example, the fourth step E4 comprises calculating 25 average circularity indices for the 25 derived images 41 constructed in the second step E2.

The method then comprises a fifth step E5 of determining, based on the average circularity indices, an optimum offset value M. The optimum offset value M is the one that best corrects the contour 21 of the drop 2 to approach a circle. The optimum offset value M is here a dimensionless real value. The optimum offset value M is indeed expressed in pixels in the sense that its value is a real number representative of a number of pixels.

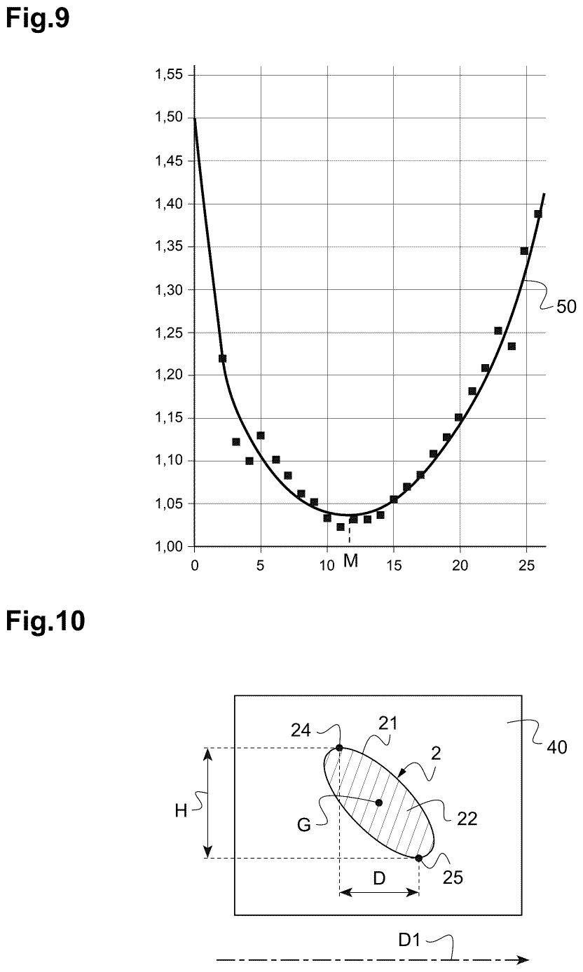

The fifth step E5 here comprises the determination by the calculator 13 of a fitting curve 50 of the average circularity indices as a function of the offset values. Each derived image 41 being associated with an offset value, each average circularity index is thus also associated with an offset value. A graphic representation of the average circularity indices as a function of the offset values appears in FIG. 9.

The fitting curve 50 is here obtained by adjusting, for example by the method of least squares, a polynomial function with, as an input, the offset values and, as an output, the average circularity indices. The fitting curve 50 is therefore a polynomial function that statistically represents the average circularity indices as a function of the offset values. The fitting curve 50 is thus obtained here by a polynomial regression. The polynomial function has for example a degree of between 2 and 6. As an alternative, the fitting curve could also be obtained by an exponential regression.

By following the preceding example, FIG. 9 illustrates the fitting curve 50 obtained for the 25 average circularity indices calculated at the fourth step E4.

Once the fitting curve 50 calculated, the calculator 13 determines the minimum of the fitting curve 50. This determination is for example made by means of an analysis of the derivative of the fitting curve 50.

As shown in FIG. 9, in this first embodiment, the optimum offset value M is then defined as the abscissa M of the minimum of the fitting curve 50. The optimum offset value M is thus the one whose image by the fitting curve 50 is minimum.

Therefore, remarkably, the accuracy on the optimum offset value M is higher than the resolution of the initial image 40 (in that it is a decimal value and not an integer) because all the offset values used to construct the derived images 41 are taken into account with the fitting curve 50.

As an alternative, it is possible not to implement the fifth step E5 and to simply determine the optimum offset value as being equal to the offset value corresponding to the smallest average circularity index.

The method then comprises a sixth step E6 of calculating the deformation rate T of the drops 2. The deformation rate T of the drops 2 is determined based on the optimum offset value M and the row time t_{L}. The calculator 13 more specifically calculates the deformation rate T as the ratio of the optimum offset value M to the row time t_{L}. The dimension of the deformation rate T is thus here the inverse of a time. The row time t_{L} being here expressed in us, the deformation rate T is expressed in pixels per microseconds.

As an alternative of this first embodiment, the maximum offset value N is not determined by the derived images are constructed until a stop criterion is reached, i.e. without knowing beforehand the number of derived images that will be constructed. In other words, a “while” loop is used instead of a “for” loop. For each derived image, the steps E3, E4 and E5 are then implemented so as to calculate the average circularity index of said derived image. The stop criterion is for example the fact that the last average circularity index calculated (i.e. that of the last constructed derived image) is higher than the average circularity index of the first derived image or the fact that the difference between the last and penultimate average circularity indices is three times higher than the variance of the average circularity indices already calculated. The fitting curve can also be adjusted as the average circularity indices are calculated. The stop criterion can then also be the fact that the fitting curve is again decreasing or reaches a second local minimum, the optimum offset value being then defined as the abscissa of the first local minimum of the fitting curve. The maximum offset value N is then that which corresponds to the stop criterion.

In a second embodiment, shown in FIG. 10, the calculator determines a deformation of the contour 21 of the drop 2 directly from the initial image 40. The deformation is representative of a difference between the shape of a drop 2 in the channel 31 and the shape of this drop 2 in the initial image 40.

For a given drop 2, the deformation is then calculated based on a difference of position between:
a first end 24 of the drop 2 which is acquired first; and
a second end 25 of the drop 2 which is acquired last.

This second embodiment can also comprise detecting the contours 21 of the drops 2 represented in the initial image 40. An average contour can then be constructed as the average of these contours 21. The first end 24 and the second end 25 are then respectively the highest and lowest points, perpendicular to the direction of the pixel rows, of the average contour.

As shown in FIG. 10, in this second embodiment, the deformation is then equal to the distance D in pixels along the rows of pixels between the first end 24 and the second end 25 of the drop 2 divided by the height H of the drop 2 in pixels along the columns. As the drop 2 is generally circular in shape in the plane P1 of the fluidic device 3, the first end 24 and the second end 25 should be located vertically to each other in a non-deformed image. The deformation is thus effectively representative of the movement of the drop 2 during acquisition of the image.

Therefore, in this second embodiment, the deformation is representative of the comparison between the shape of this drop 2 in the initial image 40 (directly or via the derived images) with a circle, i.e. with the shape of this drop 2 in the fluidic device 3 parallel to the plane P1 of the fluidic device 3.

Finally, the calculator 13 calculates the deformation rate T as the ratio of the deformation to the row time t_{L}.

As shown in FIG. 3, whatever the embodiment, the method for determining the production frequency fp then comprises a seventh step E7 of determining a distance between two successive drops 2.

Preferably, the distance between the two successive drops 2 is an average made over all the drops 2 shown in the initial image 40. This increases the accuracy of distance determination, and hence determination of the production frequency fp. For that purpose, the seventh step E7 comprises for example calculating the distance between five drops 2 produced successively, and dividing this distance by four (i.e. the number of intervals between the five drops) to obtain the distance between two successive drops 2.

The distance between the two successive drops 2 is more particularly a pitch P between these two drops 2. The pitch P is here determined based in the initial image 40. As an alternative, it can be determined based on the derived images 41.

The pitch P is here a distance between two corresponding points of each drop 2, i.e. the same respective points on each of the drops 2. By way of example, considering the most upstream point (with respect to the direction of movement of the drops, i.e. here the point furthest to the left) of a first drop 2, the pitch P with the second drop 2 is calculated as the distance between said point and the most upstream point of the second drop 2.

Preferably, the corresponding points are the centres of gravity G of the drops 2, which makes it possible to average the positions of the drops 2 for a more accurate determination of the pitch P. Using the centres of gravity G moreover makes it possible to avoid any fluctuations in diameter from one drop to the next. Therefore, preferably, the pitch P between two drops 2 is the distance between their centre of gravity G, as can be seen in FIG. 4. The pitch P between the drops 2 is then calculated as the norm of a vector connecting the centres of gravity G of the two drops 2.

As can be seen in FIG. 10. The centres of gravity G of the drops 2 are here determined by detecting the contours 21 of the drops 2 in the initial image 40 and by determining the barycentres of the contours 21. When the derived images 41 are used, the centres of gravity G of the drops 2 are here determined by detecting the derived contours 21′ and by determining the barycentres of the derived contours 21′.

The method finally comprises an eighth step E8, in which the calculator 13 calculates the production frequency fp by performing the division of the deformation rate T of the two drops 2 by the distance between the two drops 2.

Advantageously, the distance between two drops 2 is expressed in pixels in the sense that its value is a real number representative of a number of pixels. Therefore, as the deformation rate T is also expressed in pixels (per unit of time), the dimension of the calculated production frequency fp is directly the inverse of a time. In other words, it is not necessary to express the intermediate calculation values (distance, deformation rate) in metres or micrometres to determine the production frequency fp because the “pixel” dimension is cancelled out during division. This eliminates the need to calibrate the system or to determine complex optical parameters of the system 1. The system 1 can thus be implemented in a rapid and simple way.

Remarkably, the method makes it possible to determine very high production frequencies fp, for example between 10 and 60 kHz (i.e. 10,000 and 60,000 drops per second). Indeed, as shown in FIG. 4, the method is adapted to determine the production frequency fp of drops 2 that are very close to each other, or even in contact with each other.

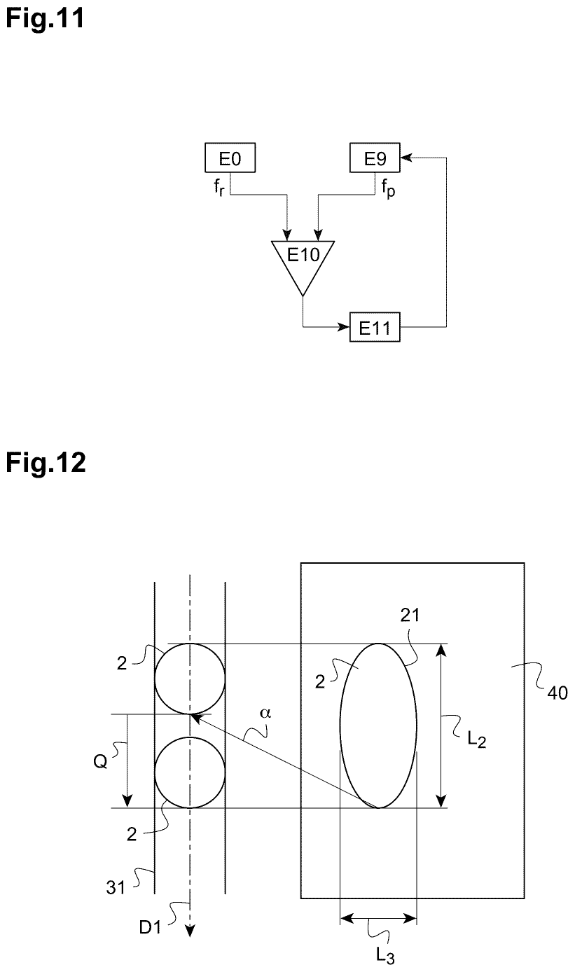

The method for determining the production frequency fp is here implemented in a method for producing drops 2 illustrated in FIG. 11. The idea of this method is, by determining the production frequency fp all along the production of the drops 2, to slave the production frequency fp to a reference frequency fr.

The method for producing drops 2 conventionally comprises the production of drops 2 in the channel 31 by injecting the sample liquid and the cladding liquid using pumps and/or syringe pumps.

As shown in FIG. 11, the method for producing drops 2 more particularly begins by a step E0 of selecting the reference frequency fr for producing the drops 2. This reference frequency fr enables to estimate initial set-points for the pressure, when pumps are used to produce the drops 2, or for the flow rate, when syringe pumps are used to produce the drops 2. These initial set-points enable to produce the drops 2 whose production frequency fp is determined as described hereinabove.

As explained in introduction, it is very complex or even impossible to estimate accurately these initial set-points so as to reach the reference frequency fr because the pressure in the fluidic device 3 varies over time. However, thanks to the measurement of the production frequency fp, the initial set-points can be modified to stabilize the production frequency fp about the reference frequency fr.

For that purpose, the method first comprises a step E9 of determining the production frequency of the drops 2 in the channel 31 by means of the method for determining the production frequency fp. Here, step E9 corresponds to the combination of steps E1 to E8 described hereinabove.

The method then comprises a step E10 of comparing the production frequency fp measured at step E9 with the reference frequency fr selected at step E10. During step E10, the calculator 13 here calculates the difference between the production frequency fp and the reference frequency fr.

The method finally comprises a step E11 of determining adjusted flow rate or pressure flow rates for the liquids injected in the fluidic device 3 upstream from the channel 31. The adjusted set-points here comprise one or several flow rate set-points and/or one or several pressure set-points. As explained in introduction, the production frequency varies over time. Therefore, the adjusted set-points are calculated so as to slave the production frequency fp to the reference frequency fr. By way of example, when the production frequency fp is less than the reference frequency fr, the adjusted injection flow rate set-point for the liquid of the drops 2 is higher than the reference set-point, so as to accelerate the production of the drops 2. Conversely, when the production frequency fp is higher than the reference frequency fr, the adjusted injection flow rate set-point for the liquid of the drops 2 is less than the reference set-point, so as to slow down the production of the drops 2.

As shown in FIG. 2, steps E9, E10 and E11 are here implemented iteratively. Therefore, the adjusted set-points enable to correct in real time the temporal variations of the production frequency fp so that it is equal to the reference frequency fr. The adjusted set-points are thus scalable over time to maintain the production frequency fp at the initial set-point value, i.e. at the production frequency fp.

Advantageously, the method for determining the production frequency fp requires little calculation power, in particular because the processing of the initial image 40 is based on simple matrix operations. Therefore, it is possible to repeat the determination of the production frequency fp at high rate, which enables to establish an accurate and fast feedback thanks to the adjusted set-points. Step E9 of determining the production frequency fp is for example executed at a rate of between 0.01 and 150 Hz.

Remarkably, the system 1 also makes it possible to implement a method for determining the velocity of the drops 2. The velocity of a drop 2 is here expressed in metres (or in units derived from the metre, such as the micrometres) per unit of time, and not in pixels per unit of time, as the deformation rate T. The velocity thus corresponds to a dimensioned value of the deformation rate T. Contrary to the deformation rate T that depends on the arrangement of the image capture device 11 with respect to the fluidic device 3, the velocity is an absolute value, independent of this arrangement.

The velocity is thus expressed in SI units. For that purpose, it is for example possible to determine the effective size, for example in micrometres, of a pixel of the initial image 40. That can be done by taking into account the optical parameters of the image capture device 11 in particular the magnification or the focal lengths of the lenses of the image capture device 11. That can also be done by taking into account a predetermined distance that is represented in the initial image, such as the width of the channel, which is for example 50 μm.

The present invention is not in any way limited to the embodiments described and shown, but the person skilled in the art will know how to apply any variant in accordance with the invention.

Likewise, the deformation may not be a single real value. For example, the deformation can be a two-dimensional representation of a drop contour. The deformation is for example recorded in the form of a table of values. It is then possible to determine the velocity by comparing this contour to a list of pre-established contours, for example during a series of tests with drops travelling through the channel at known speeds. The velocity can then be determined by searching for the pre-established contour, whose shape is the closest to the contour in the initial image, the velocity is then determined as the velocity corresponding to this pre-established contour.

The main direction along which a drop moves can also form an angle greater than 10 degrees with the rows of pixels.

In a third embodiment, the rows of pixels (always acquired sequentially) are perpendicular to the movement of the drops 2, i.e. the main direction D1. As shown in FIG. 12, when the movement of the drop 2 is perpendicular to the rows of pixels (which are here aligned horizontally), the drop 2 then has, in the initial image 40 (on the right of FIG. 12), an elongated shape with an axial symmetry along the main direction D1. This shape also provides information about the velocity of the drop 2, in the sense that it allows it to be determined: the longer the drop, the faster it goes.

For this third embodiment, during acquisition of the initial image 40, the drop 2 moves by a quantity Q in the microfluidic channel 31 (on the left in FIG. 12, the drop is shown at the beginning and at the end of the initial image acquisition) and thus appears in the initial image 40 with an oval shape.

As in the first embodiment, the method for determining the production frequency may comprise constructing derived images. The derived images are constructed by applying a variable homothety coefficient to the vertical dimension of the initial image 40. By varying this homothety coefficient, a series of derived images is obtained, in which the drop appears more or less deformed. On one of the derived images, the contour of the drop has an optimum circularity value, in the sense that the drop contour is as close as possible to a circle (the circle corresponding to the real shape of the drop, visible on the left in FIG. 12). The homothety coefficient of this derived image, schematically illustrated in FIG. 12, is called the optimum coefficient α.

This optimum coefficient a can also be obtained directly from the contour 21 of the drop 2, like in the second embodiment. It is then calculated as the ratio of the length L2 of the drop 2 in the initial image 40 to the width L3 of the drop 2 in the initial image 40. The length L2 and the width L3 of the drop 2 are expressed in pixels.

The velocity at which the drop 2 moves is then equal to: L2(1−α)/t_{L} (with L2 the length of the drop 2, α the optimum coefficient, and t_{L} the row time). The velocity of the drop 2 is thus expressed in pixels by unit of times. The terms L2(1−α) is equal to the quantity Q of movement of the drop 2 during acquisition of the initial image 40.

The production frequency is finally calculated by dividing this velocity by the vertical distance (in pixels) between two successive drops present in the initial image (at least two drops are present in the initial image although, for simplicity, only one is shown in the FIG. 12).

The drop production frequency can then be calculated on the basis of their contour, even when these latter move perpendicularly to the rows of the camera.

1. A method for determining a production frequency of a series of drops moving in a fluidic channel, the method comprising the following steps:
acquiring, using a rolling-shutter image capture device, an initial image of at least two drops in series in the fluidic channel, the initial image comprising a matrix of pixels forming rows and columns, the rows being acquired sequentially one after the other by way of the rolling shutter;
detecting, from the initial image, a contour of at least one of the two drops;
calculating the production frequency based on the contour, on a delay between the acquisition of two successive rows of pixels and on a distance between the two drops.

2. The method according to claim 1, wherein it is provided to:
construct derived images from the initial image, each derived image being associated with an offset value, the rows of each derived image being successively translated, with respect to their position in the initial image, by a number of pixels proportional to the offset value associated with said derived image;
detect, on each derived image, a derived contour of said at least one of the two drops;
determine the production frequency based on the derived contours deduced from the derived images.

3. The method according to claim 2, wherein the offset values increase from 1 to a positive integer and wherein each row of each derived image is translated, with respect to its position in the initial image, by a number of pixels equal to the offset value multiplied by an index of said row.

4. The method according to claim 2, wherein it is provided to:
calculate a circularity index of each derived contour associated with each derived image;
determine a fitting curve of the circularity indices as a function of the offset values;
determine the production frequency as a function of a minimum of the fitting curve.

5. The method according to claim 1, wherein it is provided to determine a deformation, which is representative of a difference between a shape of said at least one of the two drops in the initial image and a circular shape, based on a position difference between a first end of said at least one of the two drops in a row of pixels which is acquired first during acquiring and a second end of said at least one of the two drops in another row of pixels which is acquired last during acquiring, the production frequency being also calculated based on the deformation.

6. The method according to claim 1, wherein it is provided to:
detect a contour of the other of the two drops,
calculate the production frequency based on an average of the contour of said at least one of the two drops and on the contour of the other of the two drops.

7. The method according to claim 1, wherein an acquisition time of the initial image is less than 10 ms.

8. The method according to claim 1, wherein, the fluidic channel having a longitudinal direction, it is provided, before acquiring, to arrange the image capture device with respect to the fluidic channel in such a way that, in the initial image, the longitudinal direction of the fluidic channel forms an angle of less than 10 degrees with the rows.

9. The method according to claim 1, wherein it is provided to light the fluidic channel and said at least two drops all along acquiring using a light source.

10. The method according to claim 1, wherein it is provided to determine a centre of gravity of each of the two drops and to calculate the distance between the two drops as the distance between the two centres of gravity.

11. The method according to claim 1, wherein it is provided to determine a velocity of said at least one of the two drops based on the contour, on the delay and taking into account at least one optical parameter of the image capture device or a predetermined distance represented in the initial image.

12. A method for producing a series of drops, the series of drops moving in a fluidic channel of a fluidic device, the method comprising the following steps:
selecting a reference frequency for producing the series of drops;
determining a production frequency of the series of drops in the fluidic channel by a method according to claim 1;
comparing the production frequency and the reference frequency;
determining, based on said comparing, a flow rate or pressure set-point for a fluid injected into the fluidic device upstream from the fluidic channel to produce the series of drops.

13. A device for determining a production frequency of a series of drops moving in a fluidic channel, the system comprising a rolling-shutter image capture device adapted to acquire an initial image of at least two drops in series in the fluidic channel, the initial image comprising a matrix of pixels forming rows and columns, the rows being acquired sequentially one after the other using the rolling shutter, and a calculator programmed for:
detecting, from the initial image, a contour of at least one of the two drops;
calculating the production frequency, based on the contour, on a delay between the acquisition of two successive rows of pixels and on a distance between the two drops.

14. A drop sorting system comprising a device according to claim 13.

15. The drop sorting system according to claim 14, wherein the system is a microfluidic drops or a flow cytometer.
